(19) United States
(12) Patent Application Publication
(10) Pub. No.: US 2007/0011748 A1
(43) Pub. Date: Jan. 11, 2007

(54) Auto-license generation, registration and management

(76) Inventor: Sanjay Tiwari, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/178,790

(22) Filed: Jul. 11, 2005

(51) Int. Cl. H04N 7/16

(52) U.S. Cl. 726/26

(57) ABSTRACT

A system and methods enable recognition of devices that have pre-paid licenses such that upon receiving a request to access a management application, the management application can determine that the requesting device is a pre-paid device, generate an automatic license for the pre-paid device, and register the pre-paid device with the management application using the automatic license without reducing the number of licenses available for post-paid licenses.

### BACKGROUND

The age of technology and computers has brought an information explosion. Although computers and the ever increasing efficiencies being achieved in digital technology enable the storage of more and more information in smaller and smaller spaces, the desire for paper documents as a significant means of transferring and communicating information does not appear to be declining. To the contrary, with the explosion in information has come an explosion of paper documents.

Managing these documents can present significant problems with considerable associated costs. Fortunately, various document management devices have been developed to assist in document management. Some devices are stand-alone devices having stand-alone functionality (e.g., copiers, fax machines), while others are computer peripheral devices whose functions are integrally related to functions and applications of a computer (e.g., printers, fax machines). Still other devices provide both stand-alone and computer peripheral functionality. To further reduce the costs of managing documents, multi-function peripheral (MFP) devices provide a combination of different functions in a single device. Common MFPs include, for example, scanner/copier/printer devices and scanner/copier/printer/fax devices, which include both stand-alone and computer peripheral functionality.

While document management devices can provide a range of document management functions, their capabilities and value in managing documents can be significantly enhanced and expanded through the use of management software that executes, for example, on a host computer. Use of such management software by a device typically requires licensing and registration of the device with the software. However, the licensing and registration process can be time consuming and tedious, especially in circumstances where numerous devices are purchased by a single user/entity and each device requires an administrator to tend to a separate licensing and registration process. In addition, users often feel they should not have to endure the tedious registration process where they have already paid for a license to use the management software through the purchase price of a device.

### BRIEF DESCRIPTION OF THE DRAWINGS

The same reference numerals are used throughout the drawings to reference like components and features.

FIG. 1 illustrates an exemplary embodiment of environment suitable for implementing automatic license generation, registration and management regarding a management application.

FIG. 2 illustrates an exemplary embodiment of a host computer system suitable for implementing automatic license generation, registration and management through a management application.

FIG. 3 illustrates an exemplary embodiment of a license list.

FIG. 4 illustrates an exemplary embodiment of a license list where an auto-generated license has been generated and registered with a management application.

FIGS. 5-6 are flow diagrams illustrating exemplary embodiments of methods for implementing automatic license generation, registration and management regarding a management application.

### DETAILED DESCRIPTION

Introduction

The following discussion is directed to a system and methods that enable the automatic licensing and registration of a particular type of device with a management software application.

In one embodiment, upon receiving a request from a device to access a management application, the management application executing on a host computer recognizes and distinguishes the particular device type. The management application distinguishes between general devices that require a separately paid license (i.e., post-paid devices) and special devices whose purchase price has already included payment for a license (i.e., pre-paid devices). Once the management application determines that a requesting device is a special or pre-paid device, it automatically gathers the appropriate data from the pre-paid device and the host computer that it needs in order to generate an automatic license. The pre-paid device is then automatically registered with the management application using the auto-generated license.

The licensing and registration of the pre-paid device occurs without regard to the number of post-paid licenses that may or may not have been separately purchased and made available for use with the management application by general post-paid devices. That is, the automatic licensing and registration of a pre-paid device does not reduce the number of licenses that might be available for post-paid devices.

Exemplary Environment

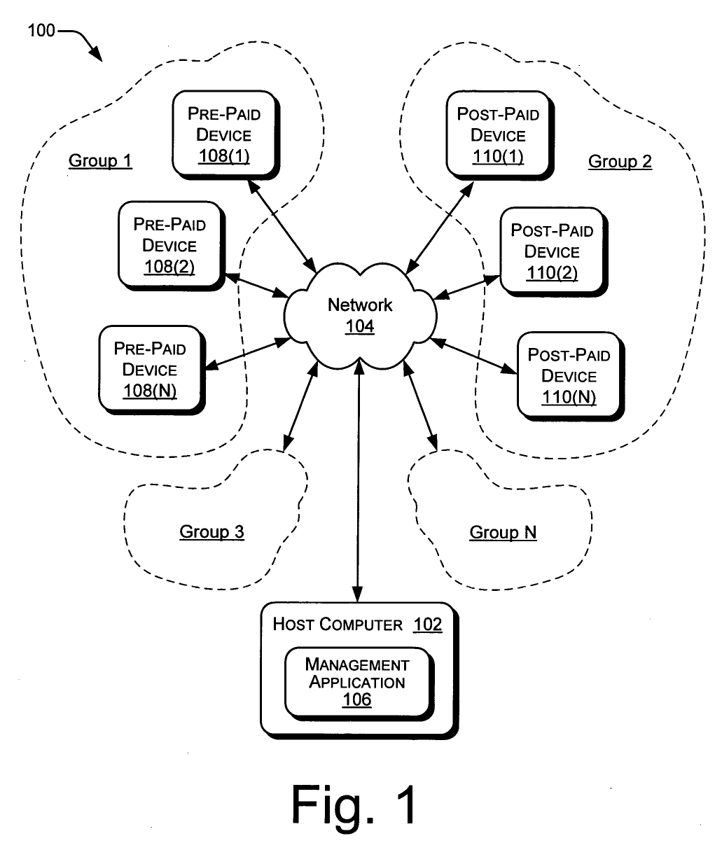

FIG. 1 illustrates an exemplary embodiment of an environment 100 that is suitable for implementing automatic license generation, registration and management with respect to a management software application configured on a host computer to enable management support and extended functionality of various peripheral devices. In the exemplary environment 100, host computer 102 may be accessible by many devices via a network 104. Network 104 can include both local and remote connections and is intended to represent any of a variety of conventional network topologies and types (including optical, wired and/or wireless networks), employing any of a variety of conventional network protocols (including public and/or proprietary protocols). Thus, network 104 may include, for example, any one or a combination of a modem, a cable modem, a LAN (local area network), a WAN (wide area network), an intranet, the Internet, a USB cable, or any other suitable communication link.

The devices shown in FIG. 1 having access to host computer 102 via network 104 may include, but are not limited to, typical stand-alone and computer peripheral devices such as printers, scanners, copiers, fax machines and multi-function peripheral devices (MFPs). The devices are illustrated in FIG. 1 as being logically grouped into different device groups (e.g., Group 1-Group N). Each device group shown in FIG. 1 is intended to indicate a grouping of a particular type of device. For example, Group 2 devices may be Type II MFP devices that have stand-alone copy and facsimile functionality as well as peripheral printing functionality, while Group 3 devices may be Type III MFP devices that have just the stand-alone copy and facsimile functionality. It is to be understood that the device groupings shown in FIG. 1 are not intended to indicate that devices within a particular group are necessarily situated in the same physical location.

Another distinction illustrated by the device groupings in FIG. 1 is the distinction between those devices that have pre-paid licenses configured for use with a management application 106 on host computer 102 and those devices that do not. Group 1 devices include devices that come with a pre-paid license upon their purchase, while the Group 2 devices do not come with a pre-paid license. Thus, Group 1 devices include pre-paid devices 108(1-N), while Group 2 devices include post-paid devices 110(1-N). A post-paid device 110 is a device that may or may not have a license for using management application 106 on host computer 102 depending on whether or not a license has been purchased separately after the post-paid device 110 was purchased.

A further distinction between devices shown in FIG. 1 is one that typically corresponds with whether a device is a pre-paid device 108 or a post-paid device 110. Because a post-paid device 110 requires obtaining a license subsequent to the purchase of the device, post-paid devices 110 generally include some stand-alone and/or computer peripheral functionality independent of the management application 106 running on host computer 102. That is, post-paid devices 110 have functionality on their own, whether or not a user intends to purchase a license to expand that functionality through the management application 106 running on host computer 102.

Pre-paid devices 108, on the other hand, already include a license because their functionality generally depends entirely on the use of the management application 106 running on host computer 102. That is, pre-paid devices 108 typically do not have stand-alone or peripheral functionality other than that derived from their use of the management application 106. Therefore, in addition to being pre-paid devices, the devices in Group 1 may also be identified by a device type, such as Type I. It should be noted, however, that it is not necessarily the case that pre-paid devices 108 have no stand-alone or peripheral functionality other than that derived from their use of the management application 106, and this not intended as a limitation on pre-paid devices 108. Thus, there may be pre-paid devices of a different type having independent stand-alone functionality identified, for example, as Type IV devices. Accordingly, although pre-paid devices 108 are discussed herein as having no stand-alone or peripheral functionality other than that which depends on management application 106 running on host computer 102, a pre-paid device 108 may also include functionality that is independent of the management application 106.

Host computer 102 generally receives device requests via network 104 for access to, and/or registration with, management application 106, and responds to such requests as directed by the management application 106. Host computer 102 is otherwise typically capable of performing common computing functions, such as email, calendaring, task organization, word processing, Web browsing, and so on. In this embodiment, host computer 102 runs an open platform operating system, such as the Windows® brand operating systems from Microsoft®. Host computer 102 may be implemented, for example, as any of a variety of conventional computing devices, including desktop personal computers (PCs), notebook or portable computers, workstations, mainframe computers, Internet appliances, print servers, handheld PCs, combinations thereof, and so on.

Exemplary Embodiments

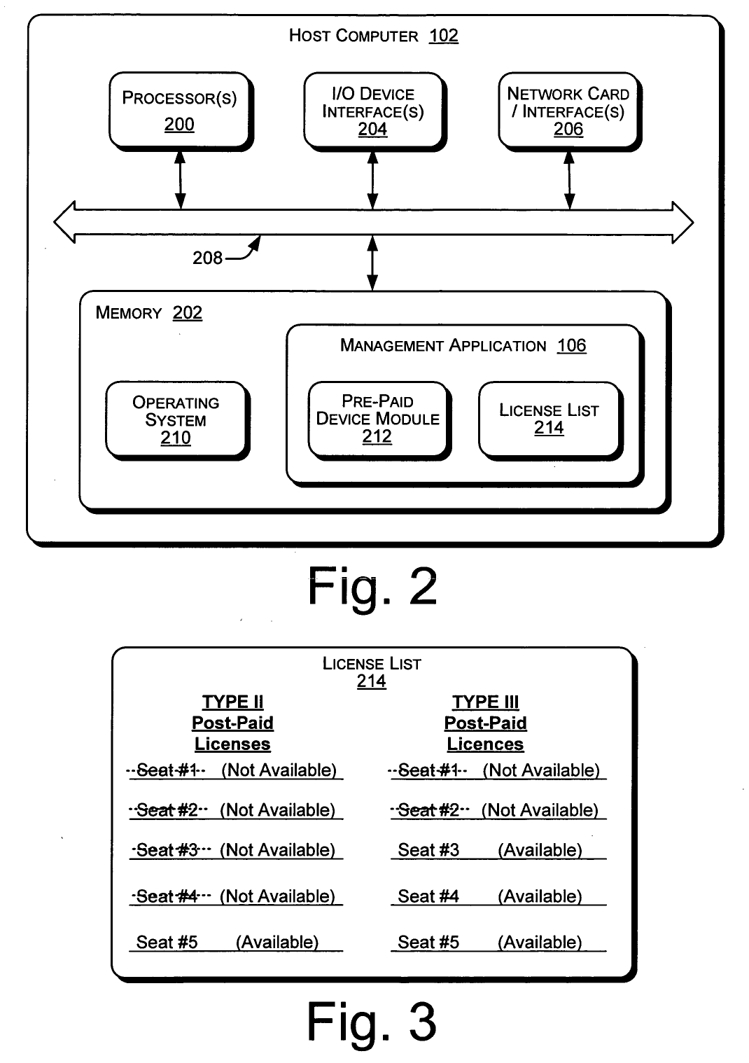

FIG. 2 illustrates an exemplary embodiment of a host computer system 102 suitable for implementing automatic license generation, registration and management to enable management support and extended functionality of various peripheral devices. While one exemplary host computer system is described herein for purposes of illustration, it should be noted that the automatic license generation, registration and management discussed herein is not limited to implementation on this particular system, but that many other systems are possible. Generally, the host computer 102 may include a processor 200, a memory 202, input/output device interface(s) 204, and network card/interface(s) 206 that are communicatively coupled via a system bus 208. The system bus 208 may be any of several types of bus structures, including wired or wireless connections, and may comprise multiple bus structures interconnected by various bridges, adapters and/or controllers.

The processor 200 is a hardware device for executing software that can be stored in the memory 202. The processor 200 can be any custom-made or commercially available processor, including a central processing unit (CPU), an auxiliary processor among several processors associated with the host computer 102, a semiconductor-based microprocessor (in the form of a microchip), or a microprocessor. When the host computer 102 is in operation, the processor 200 is configured to execute software stored within the memory 202, to communicate data to and from the memory 202, and to generally control operations of the host computer 102.

The memory 202 can include any one or combination of volatile memory elements (e.g., random access memory (RAM, such as dynamic RAM or DRAM, static RAM or SRAM, etc.)) and nonvolatile memory elements (e.g., read-only memory (ROM), hard drives, tape drives, compact discs (CD-ROM), floppy discs, etc.). Moreover, the memory 202 may incorporate electronic, magnetic, optical, and/or other types of storage media now known or later developed. Note that the memory 202 can have a distributed architecture, where various components are situated remote from one another, but can be accessed by processor 200.

The memory 202 may contain several software programs, each of which typically comprises an ordered listing of executable instructions for implementing logical functions. In the illustrated example, the software in the memory 202 includes an operating system 210 and a management application 106. However, other software programs may also be present. The operating system 210 generally controls the execution of the management application 106 and provides, for example, scheduling, input-output control, file and data management, memory management, and communication control and related services.

The input/output device interface(s) 204 may include one or more of a number of device interfaces for communicating via various devices, such as but not limited to, a keyboard, a mouse or other suitable pointing device, a microphone, a scanner, etc. Furthermore, the input/output device interface(s) 204 may also include known or later developed output devices, for example but not limited to, a printer, a monitor, an external speaker, etc. The network card/interface(s) 206 may include a host of devices capable of establishing communication sessions between the host computer 102 and network 104. Thus, the network card/interface(s) 206 may include but are not limited to, a modem (for accessing another device, system, or network), a radio frequency (RF) or other transceiver, a telephonic interface, a bridge, an optical interface, a router, and so on.

The management application 106 can be embodied in any computer-readable medium for use by host computer 102. This can be accomplished, for example, by downloading the management application 106 onto an internal memory element (such as a hard disk or integrated circuit memory device) of host computer 102 from a removable computer-readable medium (such as a floppy disk, CD-ROM, or the like) or from a remote computer system over the Internet or other computer network via the network interface(s) 206. The management application 106 could also reside on a removable computer-readable medium inserted into an appropriate drive of host computer 102 and be accessed from there. In this case, the management application 106 would be accessed directly from the removable computer-readable medium, instead of being transferred to an internal memory element. As an alternative to being contained in the memory 202, the management application 106 could reside on a remote computer system and be accessed by host computer 102 over network 104 via the network interface(s) 206.

As used herein, the term “computer-readable medium” refers generally to any medium or means that can store, communicate, propagate, and/or transport a program for use by or in connection with a computer or similar system, apparatus, or device. The computer-readable medium can be, for example, but is not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

As mentioned above, the management application 106 executable on host computer 102 is configured to enable management support and extended functionality for a variety of peripheral devices, such as those discussed above with reference to the exemplary environment of FIG. 1. The management application 106 also manages access to its support and functions by these devices through a licensing and registration process. The management application 106 manages this access differently depending on the type of device requesting the access. In the present embodiment, for example, upon receiving an access request the management application 106 first determines if the request is coming from a pre-paid device 108 or a post-paid device 110. Thus, the management application 106 is able to distinguish between the pre-paid devices 108 and post-paid devices 110 discussed with reference to FIG. 1.

In a first scenario when a device requests access to the management application 106, a pre-paid device module 212 (FIG. 2) executes in conjunction with the management application 106 to determine that the requesting device is a post-paid device 110, and not a pre-paid device 108. This determination is made based on data retrieved from the requesting device. The data retrieved from the requesting device can include, for example, device-type identification information, a device model number, etc. Because the requesting device in this scenario is a post-paid device 110, in order for the device to have access to the management application 106, there must be a post-paid license of the correct type available for use by the device. As noted above, a post-paid device 110 does not come with a license when the device is purchased, but instead a license must be purchased separately from (and typically subsequent to) the purchase of the device itself. Post-paid licenses purchased separately by a user are registered with the management application 106 by the user. Upon registration of post-paid licenses with the management application 106, the management application 106 generates a license list 214 that keeps track of available post-paid licenses for different types of devices. Thus, after determining that the requesting device is a post-paid device 110, the management application 106 checks the license list 214 to determine if any post-paid licenses of the appropriate type are available for use by the requesting post-paid device 110.

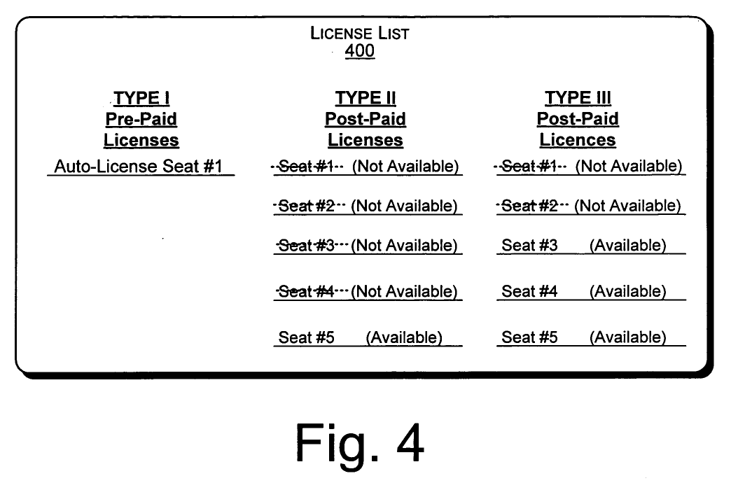

An exemplary embodiment of a license list 214 is shown in FIG. 3. In the exemplary license list 214 of FIG. 3, it is apparent that post-paid licenses have been purchased with 5 license seats for devices of Type II and Type III. Assume that the requesting post-paid device 110 device in the first scenario above is a Type II device. (A Type II device may be, for example, a post-paid MFP device having scanning, copying, and printing functionality as identified by the device's model number). Therefore, upon consulting the license list 214, the management application 106 will determine that there is still one license seat (Seat #5) available for a Type II post-paid device, and that the requesting post-paid device 110 will be allowed to access the management application 106 upon proper registration of the available license and device with the application 106.

The registration process for a post-paid device 110 is typically a tedious one that requires a user to retrieve information such as the MAC (media access control) address of the host computer 102 network card 206 and a license key associated with the available Type II license (Seat #5), from license list 214. As is generally well-known in the art, a MAC address is a code or identifier that is physically stored in a network card or interface that is used to uniquely identify the card and/or computer in which the card resides. After retrieving the appropriate information, a user provides the information to an appropriate licensing authority such as a Web site associated with the management application 106, which in turn provides the user with a license key code. A license key code is a code (e.g., a 20 digit code) that is generated to uniquely identify the license seat (e.g., Seat #5) with the device, and the host computer 102 on which the management application 106 will be running. The license key code also identifies which functions or features of the management application 106 will be enabled for use by the device. The user then enters the license key code onto the management application 106, and the management application 106 enables the appropriate functions for the post-paid device 110.

Note that the last available license seat (Seat #5) for Type II post-paid licenses has now been consumed from the license list 214, and if another Type II post-paid device 110 requests access to the management application 106, it will be refused, and the user may be informed about how to secure additional license seats from the appropriate licensing authority. However, as shown in FIG. 3, there are still three Type III post-paid licenses available should post-paid devices 110 of Type III request access to the management application 106.

In a second scenario, when a device requests access to the management application 106, the pre-paid device module 212 (FIG. 2) executes in conjunction with the management application 106 and determines that the requesting device is a pre-paid device 108. As noted above, this determination is made based on data retrieved from the requesting device. The data retrieved from the requesting device can include, for example, device-type identification information, a device model number, etc. In one embodiment, upon recognizing that the requesting device in this scenario is a pre-paid device 108, the pre-paid module 212 consults the license list 214 to determine if a registered license exists for the device. Assuming for this second scenario that the pre-paid device 108 is a Type I device, the pre-paid module 212 determines that there is currently no Type I license registered for the device in the license list 214. In this case, the management application 106 (and pre-paid device module 212) will automatically generate and register a license seat for the pre-paid device 108. In another embodiment, the pre-paid module 212 may simply generate and register a license seat for the pre-paid device 108 without consulting the license list 214.

Although similar information is used in generating and registering a license seat for the pre-paid device 108, the process is different than that of a post-paid device 110. Generating and registering a license for a pre-paid device 108 is performed automatically by the management application 106 in conjunction with pre-paid module 212. Thus, a user requesting access to the management application 106 through a pre-paid device 108 does not encounter a licensing and registration process. Rather, the management application 106 and pre-paid module 212 recognize the pre-paid device type and perform the process automatically without the need for user involvement.

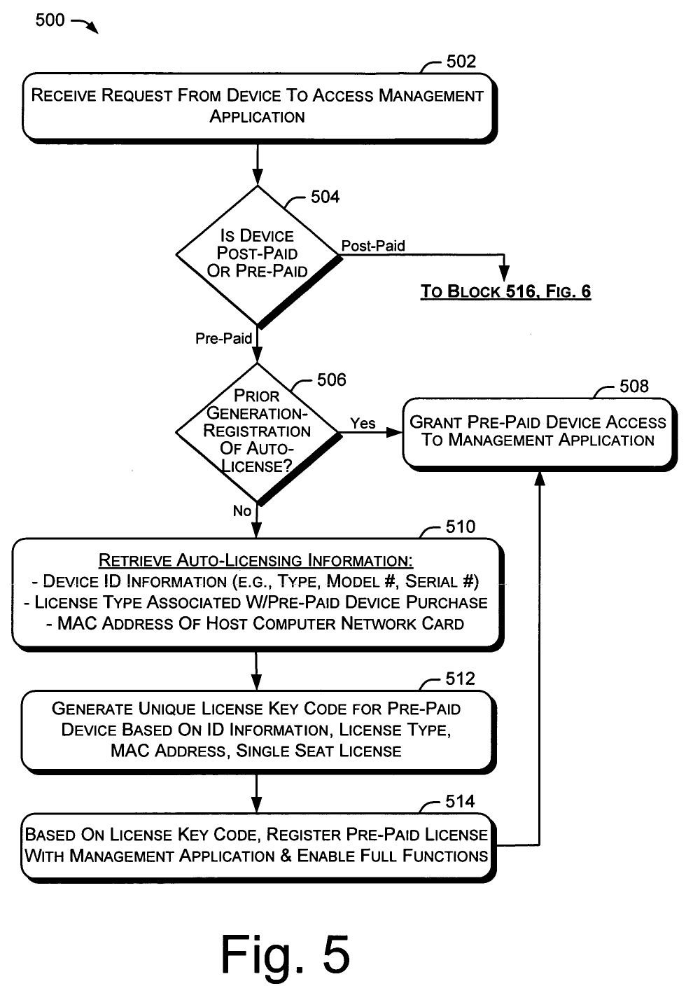

Upon recognizing an access request from a pre-paid device 108, the pre-paid module 212 automatically retrieves the appropriate information used for generating a license key code for the pre-paid device 108. The pre-paid module 212 may retrieve, for example, device-type identification information, a device model number, the MAC address as discussed above, a license Type associated with a license of the pre-paid device 108, and so on. The pre-paid module 212 then uses appropriate information, including the fact that it is generating a single seat automatic license, in order to generate a unique license key code for the pre-paid device 108. After generating the license key code for the pre-paid device 108, the pre-paid module 212 adds the auto-generated license seat to the license list that is maintained by the management application 106. FIG. 4 illustrates an embodiment of a license list 400 where such an auto-generated license seat for a Type I pre-paid device 110 has been generated and registered with the management application 106.

Because pre-paid devices 108 include a license that comes with the purchase price of the device, as noted above, license key codes generated by the pre-paid module 212 enable all of the available features and functions of the management application 106 for use by the pre-paid devices 108. In addition, upon generation and registration of an auto-license with the management application 106, there is no reduction in the number of otherwise available post-paid licenses for other post-paid devices 110. That is, the automatic generation and registration of a pre-paid license seat with the management application does not reduce the number of post-paid licenses that may have been purchased for post-paid devices.

In one embodiment, the management application 106 has a trial period in which a number of post-paid licenses (license seats) are made available for various device types. For example, when the management application is first purchased, there may be a 60 day trial period in which 50 license seats are provided for free use. In a manner similar to that discussed above, each license seat enables registration of a post-paid device 110 for use with the management application 106 during the trial period. During the trial period, each time a post-paid device 110 registers with the management application 106, the number of post-paid trial license seats is decremented by one. If all the license seats are consumed during the trial period, no more post-paid devices 110 will be allowed to use the management application 106. The management application 106 will maintain the trial license seat registrations until the trial period expires, and then it will inactivate or disable the trial license seat registrations such that the post-paid devices no longer have access to the management application 106. Further access would then require the purchase of licenses and completion of the licensing and registration process described above.

However, during the trial period, whether or not all of the trial license seats are consumed by post-paid devices 110, a pre-paid device 108 will be appropriately recognized by the management application 106 and pre-paid module 212, and will be licensed and registered automatically in a process such as that already discussed above. If there are trial license seats available, the number of trial license seats will not be affected or reduced by the automatic licensing and registration of a pre-paid device 108. Furthermore, upon expiration of the trial period, pre-paid licenses automatically generated will be maintained beyond the trial period such that pre-paid devices 108 maintain access to the management application 106. Thus, although all trial period post-paid licenses will be inactivated or disabled at the expiration of the trial period, any auto-licenses generated for pre-paid devices 108 will survive the expiration of the trial period.

In one embodiment the management application 106 is digital sending software configured to extend the functionality of devices such as pre-paid devices 108 and post-paid devices 110. The digital sending software offers various support and functions to devices 108 and 110 such as workflow functions, Internet fax, LANfax, authentication, send to folder functions, FTP (file transfer protocol) functions, printer functions, email file functions, OCR (optical character recognition) functions, operating system based services, and so on.

In one embodiment, pre-paid devices 108 are digital sender devices. In conjunction with digital sending software, a digital sender enables functions such as the automating of document workflows and the secure scanning of documents to e-mail, network folders, fax services, and printers. Digital sending software (i.e., management application 106) can extend this functionality to include direct sending to backend applications, barcode reading, form recognition, and more. In one embodiment, digital sending devices have no other functionality but for that which is associated with and dependent upon the digital sending software.

Exemplary Methods

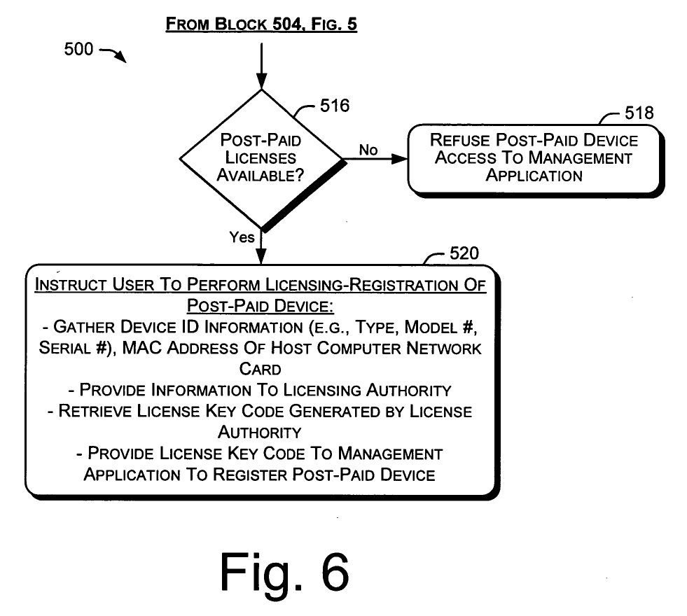

Example methods for implementing automatic license generation, registration and management to enable management support and extended functionality of various peripheral devices will now be described with primary reference to the flow diagrams of FIGS. 5 and 6. The exemplary methods apply generally to the exemplary embodiments discussed above with respect to FIGS. 1-4. While one or more methods are disclosed by means of flow diagrams and text associated with the blocks of the flow diagrams, it is to be understood that the elements of the described methods do not necessarily have to be performed in the order in which they are presented, and that alternative orders may result in similar advantages. Furthermore, the methods are not exclusive and can be performed alone or in combination with one another. The elements of the described methods may be performed by any appropriate means including, for example, by hardware logic blocks on an ASIC or by the execution of computer-readable instructions defined on a computer-readable medium.

Exemplary method 500 begins at block 502, when a device requests access to a management application. The request is typically received at a host computer 102 on which the management application 106 resides. The device is typically a computer peripheral or stand-alone device such as a printer, copier, scanner, facsimile machine, an MFP, or a digital sender device.

At block 504, the management application 106 responds to the request by determining if the requesting device is a post-paid device 110 (i.e., a device whose license to use the management application would be purchased separately from the device itself) or a pre-paid device 108 (i.e., a device whose initial purchase price includes the price of a license to use the management application). This determination typically involves retrieving and evaluating identification information from the requesting device, such as device type information, model number information, serial number information, and the like.

As shown in FIG. 5, if the requesting device is a post-paid device 110, the method continues on at block 516 of FIG. 6, discussed herein below. If the requesting device is a pre-paid device 108, the management application 106 further determines at block 506 whether an automatic license has already been generated and registered for the device. The management application 106 consults a license list 214 to make this determination. If the license list 214 indicates that an automatic license has already been generated and registered for the pre-paid device 108, the device is granted access to the management application 106 as shown at block 508.

However, as indicated at block 510, if the pre-paid device 108 does not already have an automatic license registered with the management application 106, the management application 106 retrieves the information needed to perform an automatic licensing and registration of the pre-paid device 108 with the management application 106. The information retrieved includes, for example, device identification information (e.g., device type, Model #, Serial #), a license Type associated with the pre-paid device when the device was purchased, the MAC address of the host computer 102 network card, and the like.

As shown in block 512, the management application 106 proceeds to generate a unique license key code for the pre-paid device 108 based on the information retrieved in block 510. The pre-paid device 108 is then registered with the management application using the license key code as shown at block 514. In one embodiment the license key code enables all the functionality of the management application for use by the pre-paid device 108. Once the pre-paid device is registered with the automatic license, it is granted access to the management application as shown at block 508.

As noted above at block 504, if the requesting device is a post-paid device 110, the method continues on at block 516 of FIG. 6. At block 516, of FIG. 6, the management application 106 determines if there are any post-paid licenses available in a license list 214 for use by the post-paid device 110. As discussed above, the management application 106 may provide a number of trial licenses during a trial period, after which the trial licenses will be inactivated. However, the trial licenses are for use by post-paid devices 110, as pre-paid devices will again be automatically licensed and registered without reducing the number of such trial period licenses. Furthermore, any auto-generated licenses for pre-paid devices 108 will survive the expiration of the trial period.

Generally, if the management application 106 determines there are no post-paid licenses available, the post-paid device is refused access to the management application as shown at block 518. However, if there is a post-paid license available, at block 520 the user is instructed by the management application to perform the licensing and registration procedure for the post-paid device. The procedure generally includes gathering information such as the device ID information (e.g., Type, Model #, Serial #) and the MAC address of the host computer network card, providing the information to the appropriate licensing authority (e.g., the Web site for the management application), retrieving a license key code generated by the license authority, and providing the license key code to the management application in order to register the post-paid device with the application.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
maintaining a number of post-paid licenses, each post-paid license configured to enable registration of a post-paid device with a management application, the maintaining including decrementing the number of post-paid licenses each time a post-paid device is registered with the management application;
receiving an access request from a device;
determining that the requesting device is a pre-paid device;
generating an automatic license for the pre-paid device; and
registering the pre-paid device with the management application using the automatic license without reducing the number of post-paid licenses.

2. A method as recited in claim 1, wherein generating the automatic license comprises:
retrieving device identification information from the pre-paid device;
retrieving a license Type from the pre-paid device;
determining a MAC (media access control) address of a network card associated with a host computer on which the management application executes;
determining that one license seat is needed for the pre-paid device; and
generating a unique license key code for the pre-paid device based on the device identification information, the license Type, the MAC address, and the one license seat.

3. A method as recited in claim 2, wherein registering the pre-paid device with the management application comprises using the unique license key code to:
uniquely identify the pre-paid device to the management application; and
instruct the management application what functions to enable for use by the pre-paid device.

4. A method as recited in claim 3, wherein instructing the management application comprises instructing the management application to enable all functions for the pre-paid device.

5. A method as recited in claim 1, wherein maintaining a number of post-paid licenses comprises, for each post-paid license, providing a device with access to one or more functions of the management application.

6. A method as recited in claim 1, wherein the pre-paid device is a digital sender device whose functionality is dependent upon the management application.

7. A method as recited in claim 1, wherein each device that is not a pre-paid device is a MFP (multi-function peripheral) device having one or more stand-alone functions that are operable independent of the management application.

8. A method as recited in claim 1, wherein the management application is digital sending software configured to offer functions selected from the group comprising:
workflow function;
Internet fax;
LANfax;
authentication;
send to folder function;
FTP (file transfer protocol) function;
printer function;
email file function;
OCR (optical character recognition) function; and
operating system based services.

9. A method as recited in claim 1, wherein maintaining a number of post-paid licenses comprises maintaining the number of post-paid licenses for a trial period.

10. A method as recited in claim 9, further comprising:
maintaining automatic licenses for pre-paid devices after the trial period expires; and
disabling post-paid licenses after the trial period expires.

11. A host computer comprising:
means for maintaining a number of paid licenses, each paid license enabling registration of a device for use with a management application;
means for reducing the number of paid licenses by one each time a device registers with the management application; and
means for, without reducing the number of paid licenses, automatically generating an auto-generated license for use with the management application by a pre-paid device each time a pre-paid device registers with the management application.

12. A host computer as recited in claim 11, further comprising means for denying a registration request of a device if the number of paid licenses remaining is zero.

13. A host computer as recited in claim 11, further comprising means for processing a registration request of a pre-paid device without regard to the number of paid licenses remaining.

14. A host computer as recited in claim 13, wherein the means for processing a registration request of a pre-paid device comprises:
means for generating a license key code for the pre-paid device;
means for uniquely identifying the pre-paid device to the management application with the license key code; and
means for instructing the management application which functions to enable for use by the pre-paid device.

15. A host computer as recited in claim 14, wherein means for instructing the management application comprise means for instructing the management application to enable all functions for use by the pre-paid device.

16. One or more computer-readable media having computer-executable instructions configured for:
receiving a request from a device to access a management application;
determining whether the requesting device is a pre-paid device or a post-paid device;
generating an automatic license if the device is a pre-paid device; and
registering the pre-paid device with the management application using the automatic license without affecting a number of post-paid licenses that may be available to register post-paid devices.

17. One or more computer-readable media as recited in claim 16, wherein generating an automatic license comprises:
retrieving identification information from the pre-paid device;
retrieving a license Type from the pre-paid device;
determining a MAC (media access control) address of a network card associated with a host computer on which the management application executes;
determining that one license seat is needed for the pre-paid device; and
generating a unique license key code for the pre-paid device based on the device type information, the license Type, the MAC address, and the one license seat.

18. One or more computer-readable media as recited in claim 17, wherein registering the pre-paid device with the management application comprises using the unique license key code to:
uniquely identify the pre-paid device to the management application; and
instruct the management application which functions to enable for use by the pre-paid device.

19. One or more computer-readable media as recited in claim 16, wherein the determining comprises:
retrieving device type information from the requesting device; and
evaluating the device type information.

20. One or more computer-readable media as recited in claim 16, wherein a number of post-paid licenses are available during a trial period for registering post-paid devices, the one or more computer-readable media having further computer-executable instructions configured for:
decrementing the number of post-paid licenses each time a post-paid device registers a post-paid license with the management application; and
generating and registering an automatic license for a pre-paid device with the management application without decrementing the number of post-paid licenses.

21. One or more computer-readable media as recited in claim 20, having further computer-executable instructions configured for:
de-activating post-paid licenses when the trial period expires; and
maintaining automatic licenses for pre-paid devices when the trial period expires.

22. A computer comprising:
a management application stored in a memory and executable on a processor, the management application configured for providing extended functionality to various devices upon licensing and registration of such devices; and
a pre-paid device module configured to execute in conjunction with the management application in order to distinguish between the various devices as post-paid devices or pre-paid devices and to automatically generate and register a pre-paid license enabling access to the management application by a pre-paid device while not reducing a number of post-paid licenses available for post-paid devices.

23. A computer as recited in claim 22, further comprising a license list for tracking post-paid licenses and pre-paid licenses for use with the management application.

24. A computer as recited in claim 22, wherein the management application is digital sending software and the pre-paid devices are digital sending devices.
